(19) United States
(12) Patent Application Publication
(10) Pub. No.: US 2013/0339534 A1
(43) Pub. Date: Dec. 19, 2013

(54) DEVICE INTERCONNECTION TECHNIQUE

(71) Applicant: Oner M. Bicakci, Fremont, CA (US)

(72) Inventor: Oner M. Bicakci, Fremont, CA (US)

(73) Assignee: THOMSON LICENSING, Issy de Moulineaux (FR)

(21) Appl. No.: 14/001,615

(22) PCT Filed: Mar. 2, 2011
(86) PCT No.: PCT/US11/00396

§ 371 Date: Aug. 26, 2013

(51) Int. Cl. H04L 29/08

(52) U.S. Cl. CPC H04L 29/08
USPC 709/228

(57) ABSTRACT

Communication between first device and second media device commences by first rendering accessible at least one area in the first device for access by the second device. Thereafter, the electronic first device receives identification information from the second device via a first communications modality. In response to the identification information, the first device configures itself to initiate communications with the second device via a second communications modality.

### TECHNICAL FIELD

This invention relates to a technique for enabling two physically separated media devices to exchange identification information prior to exchanging data.

### BACKGROUND ART

The advent of various modes of electronic communications has dramatically increased the desire of individuals and groups to exchange information with each other for social purposes. This phenomenon, generally referred to as “social networking” has prompted many individuals to remain electronically connected to each other via one or more devices, such as personal computers, cellular telephones, and other communication devices. The establishment of a link between two such media devices across a communication network for social purposes, sometimes referred to as “Friending”, usually requires that the devices authenticate themselves before actually exchanging information. Devices that wish to exchange information in a secure fashion but initially do not know each other must accomplish two tasks. First, the devices need to know how to contact one another. Second, once the devices know how to contact each other, they must authenticate themselves in a way that prevents others from pretending to be them. Asking users to perform these steps can prove difficult and even frightening for those who lack any technical training or experience.

A common technique for enabling two devices to authenticate each other requires that the “sending” user receive a password associated with the “receiving” device. To prevent password interception, users who seek to establish a secure communications link between their communications devices first need to establish a separate (secure) channel to exchange passwords with each other. For example, the users could verbally communicate with each other over a telephone line to exchange device passwords. After receiving the password of the other device, a user would need to determine the appropriate manner in which to enter that password. This approach to password entry can incur problems including; but not limited to weak passwords easily guessed, misunderstood and incorrectly entered passwords that fail to authenticate, poor user experience due to the inconvenience of entering passwords, and lack of use due to trepidation by unsophisticated users.

To overcome some of the aforementioned difficulties, each communication device could display its Internet Protocol (IP) address on a screen which the user would communicate during a telephone call with other user. Each user would then enter the IP address of the other device to establish a connection therewith. Unsophisticated users will likely become confused and overwhelmed at the prospect of entering a long and unfamiliar string of numbers. The use of a domain name for a device represented as a long series of letters http://www.technicolor.com/mymediaserver/BossuH would also pose difficulties for an unsophisticated user.

Thus, a need exists for a technique to allow communications devices to exchange identification information for authentication purposes with limited user intervention.

### BRIEF SUMMARY OF THE INVENTION

Briefly, in accordance with a preferred embodiment of the present principles, a method for establishing communication between first device and second media device commences by first selecting at least one area within the first media device accessible by the second device. Thereafter, the electronic first device receives identification information from the second device via a first communications modality. Thereafter, the first device configures itself to initiate communications with the second device via a second communications modality in accordance with the identification information identifying the second device.

### BRIEF DESCRIPTION OF THE DRAWINGS

FIG. 1 depicts a block schematic diagram of two media devices communicating in accordance with the technique of the present principles; and

FIG. 2 depicts in flow chart form the steps of the communication technique of FIG. 1.

### DETAILED DESCRIPTION

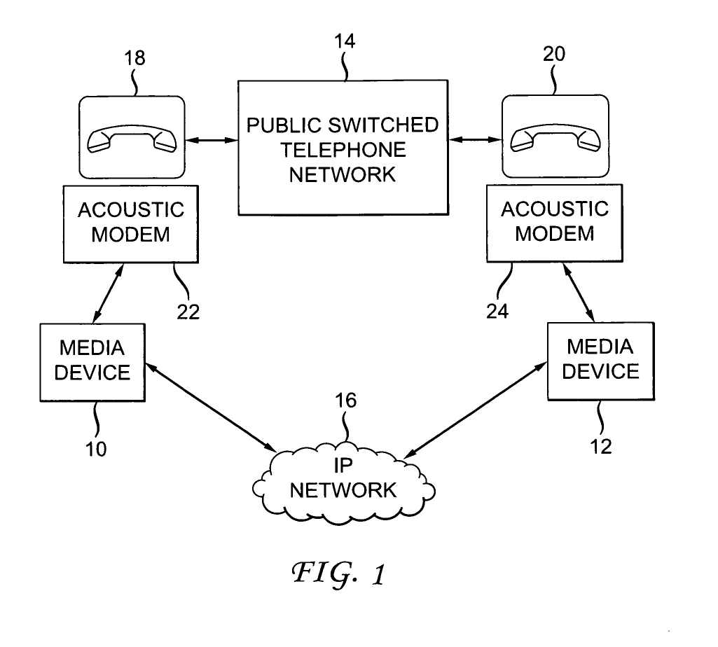

FIG. 1 depicts a block schematic diagram illustrating the manner in which first and second media devices 10 and 12 can communicate with each other with minimal user intervention. In the illustrative embodiment depicted in FIG. 1, the first and second media devices 10 and 12 could take different forms, such as a set-top box or a computer, or other such device capable of uploading and downloading information, including but not limited to media files. Regardless of their form, the first and second media devices possess the ability to communicate with each other using two different communication modalities, typically voice and IP protocol. In the illustrative embodiment, the first and second communications devices 10 and 12 have the ability to communicate via voice over the public switched telecommunications network (PSTN) 14 and via IP protocol over an Internet Protocol (IP) network 16 such as the Internet. As discussed below, the ability of the media devices to communicate with each other over both the public switched telephone network 14 and the IP network 16 allows the devices to initially exchange identification information over the PSTN in a secure manner to facilitate the subsequent exchange of information between the devices across the IP Network 16, all with minimal user intervention.

Before the media devices 10 and 12 can communicate with each across the IP network 16 for the first time, the devices must identify themselves, typically by their IP addresses. Ordinarily, the user of each media device would need to manually enter the IP address of the other device, an intimidating task for the technically unsophisticated. However, in accordance with the communication technique of the present principles, the users of the media devices 10 and 12 can readily exchange identification (e.g., IP addresses) by simply having the devices “talk” to each other across the PSTN 14 during a telephone call between users.

To initiate such “talking” between the media devices 10 and 12 during a telephone call between users, the users would place their telephone handsets 18 and 20, respectively, in a corresponding one of acoustic modems 22 and 24, respectively. Each of acoustic modems 22 and 24 connects to a separate one of the media devices 10 and 12, respectively, and to the PSTN 14. With each telephone handset placed in a corresponding acoustic modem, each user will cause their corresponding device to exchange identification information with the other device. For example, each of media devices 10 and 12 could have a dedicated button bearing appropriate indicia such as “Make Friend” which the user could actuate to commence the exchange identification information. In advance of the user actuating the “Make Friend” button, the user would need to make sure his or her media device was on and connected to the IP network 16. In practice, the media devices 10 and 12 exchange identification information using Dual-tone multi-frequency signaling tones (DTMF) which the devices audibly generate into the microphone of the telephone handset. The audible tones typically include identifying information (such as the device name and IP address) as well as a password (even allowing for unique passwords specific to each friend).

Although FIG. 1 depicts the acoustic modems 20 and 22 as entities separate and apart from the media devices 10 and 12, respectively, the functionality of each acoustic modem could readily be included in its associated media device. Thus for example, the media device 10 could include a microphone and speaker (not shown) for acoustic coupling to the telephone handset 18, as well as the necessary circuitry for converting electrical signals to audible tones and vice versa.

Before the user presses the “Make Friend” button or takes such other action to initiate the exchange of identification information, the user of each media device will typically an area or areas available for access by the other device. Selecting one or more areas for access enhances security by reducing the likelihood of unauthorized access to sensitive areas within the device.

Once each media device receives and correctly interprets the audible tones sent by the other device, then the electronic will then broadcast its own IP address to the other media device. During the exchange of information, the media devices 10 and 12 will update their displays based on the success (and/or errors encountered). To assure authentication, only one user needs to create a password for communication between the two devices. However, both of media devices 10 and 12 can require passwords. Moreover, in addition to exchanging identification information, both of the media devices 10 and 12 can make use of “handshaking” techniques to make the exchange more robust. For example, during the exchange of information, both media devices 10 and 12 could echo back what each device received.

Also, the exchange of identification information will typically include the exchange of information affording certain privileges to the devices. As discussed above, in advance of exchanging identification information with another device, a user will first designate the area or areas within his or her device available for access by a remote device. For example, the user of device 10 could allow the user of device 12 to gain access to certain stored information, say vacation pictures, but restrict accessing to other stored information, say music files. The user of each device would typically make such restrictions via a user interface specifically designed for this purpose.

Rather than make use of the PSTN 14 and the IP network 16, the communications technique of the present principles could make use of a single communications network, say the IP network 16, using two different communications modalities, such as Voice Over Internet Protocol (VOIP) and Internet Protocol. Thus, rather than make use of the PSTN 14 to exchange identification information by audible tones, such exchange could occur using VOIP, followed by the exchange of media or other such information over the IP network 16.

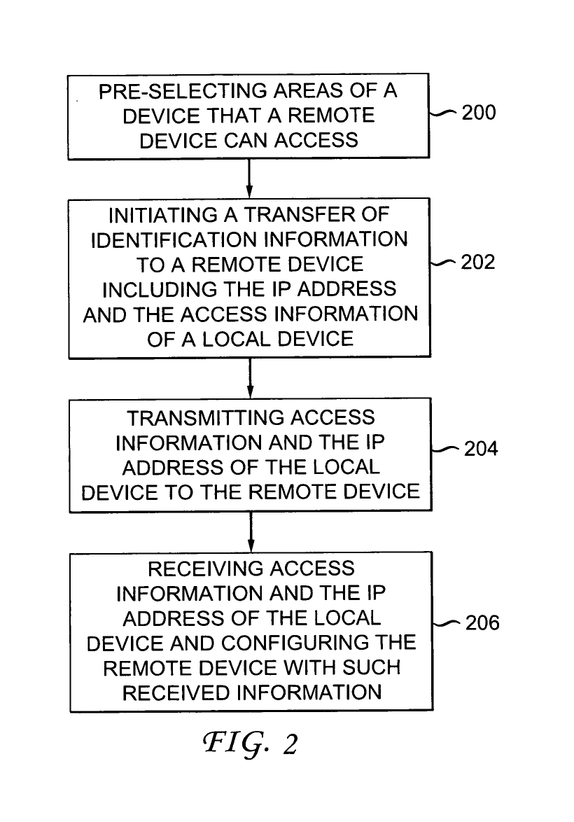

FIG. 2 depicts a flow chart diagram illustrating the steps associated with technique of the present principles for communicating between media devices. The communications technique of FIG. 2 commences by the user who first pre-selects one or more areas of his or her device accessible by a remote device (step 200). As discussed previously, pre-selecting the areas accessible to a remote device greatly reduces the incidence of unauthorized access to sensitive information. Following step 200, the user of a device initiates the transfer of identification information (e.g., the device IP address) to a remote device during step 204. Typically, the user initiates transfer of the information by launching a telephone call to the remote device, either using the PSTN 14 of FIG. 1 or using VOIP. Assuming that the transfer of identification information occurred successfully during step 204, the device receiving the identification information will then appropriately configure itself to communicate with the remote device across the IP network 16 of FIG. 1 during step 206 of FIG. 2.

The foregoing describes a technique for initiating communications between two media devices with substantially no user intervention.

1. A method for establishing communication between first and second media device, comprising the steps of:
rendering accessible at least a portion of the first device for access by the second device;
receiving at the first device identification information from the second device identifying the second device using a first communication modality; and
configuring the first device to initiate communications with the second device using a second modality in accordance with the identification information so the second device can access the first portion of the first device.

2. The method according to claim 1 wherein at least the portion of the first device is rendered accessible in response to a user command.

3. The method according to claim 2 wherein the user enters the command through an interface designated for such command.

4. The method according to claim 1 wherein the identification information from the second device is received during a voice telephone call.

5. The method according to claim 1 wherein the configuring step includes the step of initiating communications using IP protocol.

6. The method according to claim 4 wherein the voice telephone call is launched over a public switched telecommunications network.
